(19) United States
(12) Patent Application Publication
(10) Pub. No.: US 2011/0305339 A1
(43) Pub. Date: Dec. 15, 2011

(54) Key Establishment for Relay Node in a Wireless Communication System

(76) Inventors: Karl Norrman, Stockholm (SE); Rolf Blom, Jarfalla (SE); Gunnar Mildh, Sollentuna (SE); Ingrid Nordstrand, Sundbyberg (SE)

(21) Appl. No.: 12/964,991

(22) Filed: Dec. 10, 2010

Related U.S. Application Data
(60) Provisional application No. 61/384,430, filed on Sep. 20, 2010.
(60) Provisional application No. 61/353,869, filed on Jun. 11, 2010.

(51) Int. Cl. H04K 1/00

(52) U.S. Cl. 380/270

(57) ABSTRACT

Techniques for providing additional security for the wireless interface between a relay node and a donor base station are based on a security association established between the relay node and the donor base station. In an example method implemented in a relay node, communications with a donor base station are established and a first cryptographic key is generated according to a radio access protocol. A security association between the relay node and the donor base station is then established, using a credential stored at the relay node, and a second cryptographic key is derived from the first cryptographic key, using the stored credential, or one or more parameters relating to the security association, or information exchanged within the security association. The second key is used to protect user plane data relayed from one or more mobile terminals to the donor base station.

### RELATED APPLICATIONS

This application claims priority under 35 U.S.C. §119(e) to U.S. provisional patent applications Ser. No. 61/384,430, filed Sep. 20, 2010, and Ser. No. 61/353,869, filed Jun. 11, 2010. The entire contents of both of these provisional applications are incorporated by reference herein.

### TECHNICAL FIELD

The present invention relates generally to wireless communication systems and more particularly relates to data security in wireless networks that support relay nodes.

### BACKGROUND

The 3rd-Generation Partnership Project (3GPP) is currently standardizing relay nodes for the Long Term Evolution (LTE) radio access technology. These relay nodes (or relays, for short) connect to an LTE network using the same, standard radio link to LTE base stations (called evolved Node-Bs, or eNBs) used by ordinary mobile terminals (user equipment, or “UEs,” in 3GPP terminology). Each relay node then provides radio access to terminals, effectively emulating an eNB from the perspective of the mobile terminals, and uses its radio link to the eNB as backhaul transport for the terminals data.

The architecture and concepts of LTE relay nodes are documented in a technical report titled “3rd Generation Partnership Project; Technical Specification Group Radio Access Network; Evolved Universal Terrestrial Radio Access (E-UTRA); Relay architectures for E-UTRA (LTE-Advanced); (Release 9),” 3GPP TR 36.806, v. 9.0.0 (March 2010). The concept of LTE relays has also been described in the E-UTRAN stage 2 document titled “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10),” 3GPP TS 36.300, v. 10.0.0 (June 2010.

The security for LTE is defined in a 3GPP specification titled “3rd Generation Partnership Project; Technical Specification Group Services and Systems Access; 3GPP Systems Architecture Evolution (SAE); Security Architecture; (Release 9),” 3GPP TS 33.401, v. 9.4.0 (June 2010). However, the use of relay nodes in LTE system presents new security challenges.

### SUMMARY

In various embodiments of the invention, additional security for the wireless interface between a relay node and a donor base station is based on a security association established between the relay node and the donor base station. The presence of this security association, which is generated from a credential stored at the relay node, indicates a trust relationship between the relay node and the donor base station. More specifically, enhanced security of the wireless interface is obtained by generating a first cryptographic key according to a conventional radio access protocol and then generating a second cryptographic key from the first key, using the stored credential, a parameter related to the established security association, and/or information exchanged within the security association. The second key is subsequently used to provide integrity protection and/or confidentiality protection of user plane traffic, including user control plane traffic, sent over the link between the relay node and the donor base station. In various embodiments, establishing the security association may comprise establishing an IPsec tunnel or a Transport Layer Security (TLS) tunnel between the relay node and the donor base station.

Several embodiments of the above-described technique are detailed herein. In an example method implemented in a relay node, communications with a donor base station are established and a first cryptographic key is generated according to a radio access protocol. A security association between the relay node and the donor base station is then established, using a credential stored at the relay node, and a second cryptographic key is generated, based on the stored credential, or one or more parameters relating to the security association, or information exchanged within the security association. The second key is used to protect user plane data relayed from one or more mobile terminals to the donor base station. A corresponding method for implementation at the donor base station is also described, in which the second key is used to protect user plane data relayed from the donor base station to one or more mobile terminals.

In some embodiments of either of these methods, establishing a security association between the relay node and the donor base station includes the establishment of an IPsec tunnel. In other embodiments, a TLS tunnel is established. In several embodiments, a radio access protocol protection key is used to derive the second cryptographic key, although the same techniques can be used to derive other types of cryptographic keys.

In several embodiments, an intermediate key is generated from the stored credential, or one or more parameters relating to the security association, or information exchanged within the security association. The intermediate key is then used to derive the second cryptographic key. This can be done in any of several ways, including by XORing the intermediate key and the first cryptographic key to obtain the second cryptographic key, or by using the intermediate key, or a product of the intermediate key, or both, as an input to a pre-determined key generation function, to produce the second cryptographic key. Alternatively, the intermediate key or a product of the intermediate key, or both, may be used in an initialization vector of a security algorithm. In any case, the intermediate key may be generated using information encrypted and exchanged within the security association.

In another aspect of the present invention, the presence or absence of a security association between the relay node and the donor node can be used to determine whether access to the network should be limited. Accordingly, in an example method according to this aspect, a security association between a relay node and the donor base station is established, based on a credential stored at the relay node, and network access provided to the relay node is restricted until the security association is established. In several embodiments, the relay node is allowed only to access an enrollment server and/or some Operation and Maintenance (OAM) servers, for retrieval of operator security credentials, prior to establishment of the security association. As with the other methods summarized above, the establishment of the security association may comprise establishing an IPsec tunnel or establishing a Transport Layer Security (TLS) tunnel, where the presence of the IPsec or TLS tunnel indicates to the donor base station (or other network node) that the restrictions on network access for the relay node should be removed or lessened.

Apparatus configured to carry out the methods summarized above are also described, including a relay node and a donor base station.

Of course, the present invention is not limited to the embodiments, contexts, and features summarized above, nor is it limited to the specific example embodiments detailed below. Instead, it will be understood that the present invention may be carried out in ways other than those specifically set forth herein without departing from essential characteristics of the invention as set forth in the appended claims. Upon reading the following description and viewing the attached drawings, the skilled practitioner will thus recognize that the described embodiments are illustrative and not restrictive, and that all changes coming within the scope of the appended claims are intended to be embraced therein.

### BRIEF DESCRIPTION OF THE DRAWINGS

FIG. 1 illustrates components of an example LTE network with a relay node.

FIG. 2 is a process flow diagram illustrating a method for providing secure relay node services in a wireless communication system.

FIG. 3 is another process flow diagram illustrating a method for providing secure relay node services.

FIG. 4 is another process flow diagram illustrating a method for providing secure relay node services.

FIG. 5 is a block diagram illustrating components of an example relay node.

FIG. 6 is a block diagram illustrating components of a donor base station.

### DETAILED DESCRIPTION

Aspects of the present invention are disclosed herein in the context of a Long-Term Evolution (LTE) system, as specified by the 3^{rd}-Generation Partnership Project (3GPP). However, those skilled in the art will appreciate that the inventive techniques disclosed herein are not limited to LTE-based implementations, but are more generally applicable to security for relay nodes in wireless communication systems. Accordingly, while this disclosure largely adopts the terminology of the 3GPP, this terminology should be understood generically where the context permits. For example, 3GPP uses the term “donor base station” or “donor eNodeB” (DeNB) to refer to a (usually fixed) base station that provides radio network access to one or more relay nodes. This term should be viewed as a synonym to “host base station” or other terms used to describe similar nodes in other wireless networks. Likewise, the 3GPP term “User Equipment” or “UE” as used herein should be understood to refer generically to radio access terminals, which might otherwise be referred to as “user terminals,” “mobile terminals,” “mobile stations,” and the like, and may refer to devices used in machine-to-machine (M2M) applications as well as to devices carried or generally used by individual users.

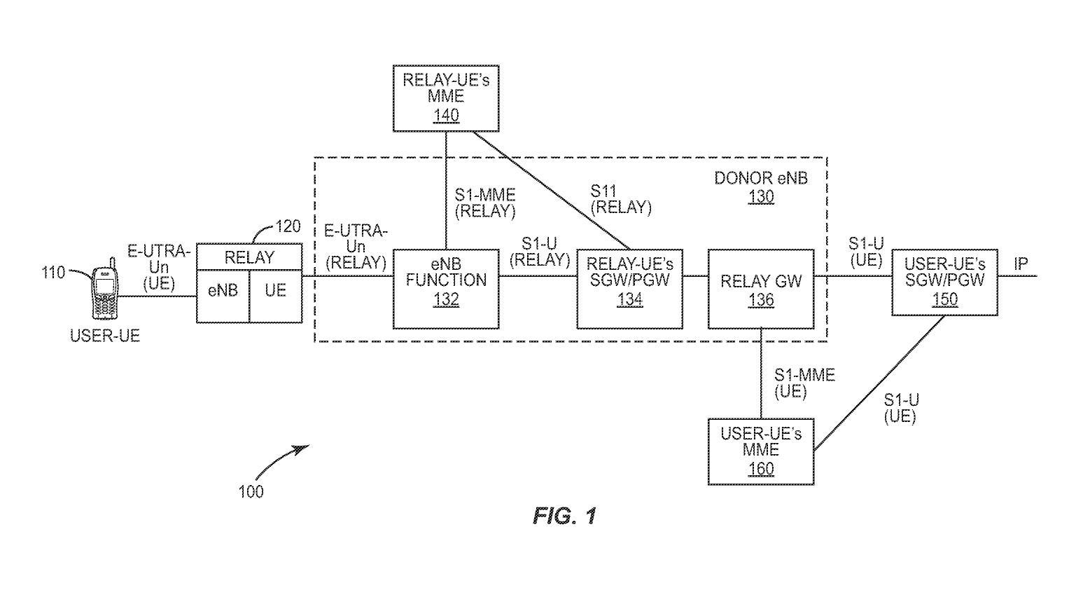

FIG. 1, adapted from discussion documents used by the 3GPP working group on security, illustrates the basic architecture of an LTE network 100 configured to support relay services. User-UE 110 is the mobile terminal that the end user uses to receive service from the LTE network 100; these services are generally provided by LTE base stations, or “evolved NodeB's” (eNBs), but may be instead be provided by a relay node under certain circumstances. In FIG. 1, for example, User-UE 110 is obtaining access to the network through relay node 120. The reference point defining the interface between User-UE 110 and relay node 120 is known as the Uu reference point. This is the same reference point as between a UE and a conventional eNB.

The relay node 120 comprises two parts. One part is the UE-persona, which is used by the relay node to connect to the LTE network. The other part is the eNB-persona, which the relay node uses to provide LTE access to User-UEs. From the perspective of the User-UE, the relay node 120 looks like any other eNB; relay node 120 can thus be thought of as a base station that uses LTE for its backhaul transport.

In FIG. 1, relay node 120 accesses the LTE network through donor eNB 130, which is an LTE base station that provides radio access to the relay node 120, and which may also provide radio access to other relay nodes and/or user terminals. The reference point between the relay node 120 and the donor eNB 130 is designated the Un reference point, which is a modified version of the normal radio access interface.

Within the donor eNB 130, the eNB function 132 provides network access for the UE-persona in relay node 120. Among other things, eNB function 132 provides the relay node 120 with access to relay-UE's MME 140, which is the MME (Mobility Management Entity) that the relay node connects to and authenticates against to get access to the LTE network. The donor eNB also includes a relay-UE's SGW/PGW function 134, which provides serving gateway (SGW) and PDN gateway (PGW) functionality for the relay node 120, and a relay gateway (GW) 136, which separates the user-UE control plane and user plane traffic from the relay node traffic, connecting the user-UE 110 to User-UE's MME 160 and User-UE's SGW/PGW 150. The term “User-UE control plane” is used to refer to the control plane traffic between the relay node 120 and the MME 160 controlling the User-UE 110.

One important security issue in relay node networks involves integrity protection for User-UE control plane traffic. When the relay node provides LTE services for User-UEs, it must send and receive User-UE's control plane traffic for these User-UEs to and from the LTE network. In particular, the relay node communicates with the MMEs that are controlling the User-UEs, via Data Radio Bearers (DRBs) between the relay node and the donor eNB. However, these DRBs do not provide integrity protection. Accordingly, integrity protection must be separately provided for this User-UE control plane traffic in some other way, as an attacker could otherwise modify or inject User-UE control plane traffic on the Un reference point.

Several ways to provide integrity protection for the User-UE control plane traffic have been discussed. One possibility is to add integrity protection to the DRBs (or at least to some of them). This approach has the drawback that it requires substantial changes to the existing radio protocols, namely, PDCP (Packet Data Convergence Protocol) and RRC (Radio Resource Protocol). Another approach is to establish a security association between the relay node and the donor eNB to add security “on top” of the DRBs. For instance, an IPsec tunnel can be established on top of a DRB, to provide integrity protection for the traffic. This approach has less of an impact on existing protocols.

Another security issue raised by the use of relay nodes is confidentiality protection for User-UE control plane traffic. However, this traffic is already encrypted by PDCP unless the NULL-ciphering algorithm is used. It is possible to add additional encryption using the security association (e.g., IPsec tunnel) mentioned above, but the gain in doing so seems small.

In addition to protecting the integrity of the User-UE control plane traffic transmitted over the Un reference point, it is also necessary to protect the processing of traffic inside the relay node. This is a similar requirement as is put on normal LTE base stations. The reason is that the relay node may be located in a hostile environment where an attacker could physically break into the relay node. The attacker could then get access to the User-UE control plane traffic even if it is integrity protected (and ciphered) over the Un reference point. Further, just as in an LTE base station, it is necessary that the relay node decrypt the User-UEs user plane traffic inside a secure environment and re-encrypts it before transmitting it to the donor eNB. Otherwise the attacker physically breaking into the relay node could get access to the User-UE's user plane data.

Therefore, the relay node must provide a secure environment where the User-UE user plane traffic can be decrypted and re-encrypted for backhaul transport over Un. There is also a need for a secure environment where the User-UE control plane traffic is handled and encrypted and/or integrity protected for transport over Un. Of course, these two secure environments may be provided using the same hardware.

When the relay node connects to the LTE network, it uses its UE-persona and attaches much like a normal User-UE does. Hence, the relay node likely will run the LTE authentication protocol to authenticate itself towards the LTE network and authenticate the network. The LTE authentication protocol also provides the LTE network and the UE with shared keying material. The LTE authentication protocol uses the smartcard-based USIM (Universal Subscriber Identification Module) as an authentication credential.

Much of the security-related discussions in 3GPP efforts are directed to ensuring that the communication between the USIM and the secure environment where the ciphering of the User-UE's user plane traffic is handled cannot be monitored by an attacker with physical access to the relay node. If the attacker had access to this communication he would be able to decrypt the user plane traffic over Un and thereby get plaintext access to the User-UE's user plane traffic. Because of these concerns, several proposed solutions either require that the USIM credentials are stored directly inside the secure environment, or require that the USIM smartcard is physically and securely connected to the relay node secure environment (e.g., by covering it in special glue or ceramics, or by using a smartcard with a special form factor). There is also a proposal to provide cryptographic protection of the communication between the USIM and the secure environment.

Assuming that a USIM is available in the relay node, this USIM can be used to authenticate the relay node to the MME and the relay node can be granted IP connectivity via a donor eNB (or any other eNB). However, if the access provided by the donor eNB is a general purpose access, this access could potentially be used to get service from the network that could be misused. Thus, there should be some way for the MME to inform the donor eNB that this relay node is only allowed restricted access. That is, the relay node is only allowed to communicate with the enrollment server and/or some Operation and Maintenance (OAM) servers in the O&M (Operations and Maintenance) network.

Once IP connectivity to the enrollment server is established, the same procedures used conventionally for enrollment of macro eNBs can be used to enroll an operator certificate in the relay node. The relay node generally has been provisioned with a vendor certificate and corresponding private key in the factory, and uses CMPv2 to enroll the operator certificate. This gives the benefit that the certificate handling can be exactly the same as for macro eNBs.

There are two problems that need to be addressed for the above approach to work. A first problem is how to ensure that the relay node is only allowed to access the O&M network or possibly only the enrollment server before it is enrolled. A second problem is how to make the USIM available in the relay node.

The first problem can be solved by checking whether the donor eNB has established a security association with the relay node, which can only be done with a properly enrolled operator certificate. For instance, if an IPsec tunnel is used to provide integrity protection for the User-UE control plane signaling, as suggested above, the system can check to see if the IPsec tunnel to the relay node has been established. When the donor eNB notices that a tunnel does not exist, it only provides the relay node with IP connectivity to a specific part of the network, e.g., only to the enrollment server. Other possibilities for determining whether the relay node is properly enrolled may exist. However, it should be noted that the MME does not have access to any information regarding whether the relay node has enrolled an operator certificate or not and hence cannot directly provide this information to the donor eNB in the User-UE control plane setup for the relay node.

The second problem regarding how a USIM can be made available to the relay node is more complex. There are several possibilities. First, the USIM credentials can be hard coded in the relay node's secure environment in the factory. Second, the USIM can be physically made part of the secure environment in the factory. Third, the USIM can be inserted by a field engineer and then be physically made part of the secure environment. In this case, a mechanical locking or gluing solution would be required to guarantee that the USIM remains integrated into the secure environment. Finally, in an alternative approach, the USIM can be inserted by a field engineer when the relay node is deployed and not made part of the secure environment. In this case, the interface between the UISM and the secure environment may be protected or not.

It is noted that each of the first and second approaches make it impossible to get a late binding between the USIM identity and the relay node device identity, the location of the relay node, which operator owns the credentials on the USIM, etc. The third approach potentially allows the USIM to be removed from the relay node. Further, requiring that the field engineer shall be able to securely make the USIM part of the secure environment puts very high demands on the competence of the field engineer and requires a high level of trust in the field engineer. With regards to the deployment of macro eNBs, it has previously been clear that there were use cases where the field engineer could not be trusted by the operator with credentials. The same concerns apply to the installation and maintenance of relay nodes.

The fourth method requires only that a field engineer insert a USIM into the relay node. The USIM may be removable. However, if a secure channel between the USIM and the secure environment is required this implies requirements on the relay node and the UICC (Universal Integrated Circuit Card) to support such functionality, including handling and holding of the required credentials. However, it should be noted that if a field engineer provisions the USIM during installation of the relay node, there is an opportunity to include other data on the USIM as well, such as the address or identity of the enrollment server, etc.

A basic concept of some embodiments of the security approach described herein is to secure user plane data relayed from a mobile terminal to a donor base station using a key K that is derived from a credential used to establish a security association between the relay node and the donor eNB. The security association may be used to establish a tunnel, such as an IPSec tunnel or a Transport Layer Security (TLS) tunnel for securing User-UE control plane traffic, as discussed above. In any case, the derivation of this key could be done in one or more steps, and could include the use of one or more different parameters that ensure “freshness” of the key, and can be based on or more different types of binding properties, e.g., binding to the particular algorithms used for the traffic protection.

At its most basic level, the above approach doesn't require any exchange of information between the donor eNB and the relay node to derive the key, above and beyond the signaling used to establish the security association and any secure tunnel. Of course, if the key derivation process involves the use of freshness parameters, these parameters would in many cases have to be transferred between the donor eNB and the relay node, either inside or outside an IPsec or TLS tunnel.

In some systems, accessing the credentials to establish the security association and using those credentials for other purposes may be difficult, or inconvenient. Furthermore, basing the intermediate key K on the credentials used to establish the security association may create uncertainties as to the appropriate key K to use when the security association changes, i.e., due to key re-negotiation. Thus, a related approach is to derive the key K from information sent between the relay node and the donor eNB within an established security association, e.g., inside an established IPsec or TLS tunnel. The exchanged information used to derive the key K can include random data generated in the donor eNB, the relay node, or both, or a counter or timestamp generated at either or both ends, or identities for one or both of the nodes, etc.

A combination of these approaches is also possible. Thus, the key derivation may also be based on information derived from credentials used to establish a security association between the relay node and the donor eNB, as well as information exchanged within the security association. The derivation of the key K could be done in one or more steps, and could include the use of one or more different parameters that provide freshness or different types of binding properties, e.g., binding to the particular algorithms used for the traffic protection.

In some cases, the derived key K may be established at one node and securely sent to the other, e.g., inside an IPsec tunnel. In others, the derived key K may be a “shared secret” generated at both ends from information exchanged through a tunnel. However, it should be noted that the existence of the security association indicates that there is already a trust relationship between the nodes. Thus, this latter approach is not strictly necessary. For similar reasons, the use of freshness data in the generation of the key K may be desirable, but is not required.

In either approach, the intermediate key K is then used to affect the ciphering and integrity protection provided by the radio access protocol PDCP (Packet Data Convergence Protocol). This can be done in such a way that no changes need to be made to the key handling for the PDCP protocol.

For example, the key K may be X-ORed with one or more the cryptographic keys used in standard Access Stratum (AS) security schemes, i.e., K_{UP-enc}, K_{RRC-enc}, and the integrity key K_{RRC-int}. Alternatively, the key K may be included in the generation of these keys in other ways, or may be used as an input to directly to the encryption and integrity protection of the data or signaling. One example is that the K_{eNB} is modified before being input to the Key Derivation Function that generates the keys mentioned above. The intermediate key K could also be included in the generation of the key input to the actual integrity and ciphering algorithms (which in current specifications are the keys above). The resulting security parameters, including any modified keys as discussed above, will in the following be referred to as a modified AS security context.

Thus, one approach to relay node security involves the following steps. First, keys for the PDCP protocol are established when the relay node attaches to LTE, just as when any other terminal attaches to LTE. Second, a security association is established between the relay node and the donor eNB. This may involve, for example, the establishment of an IPsec tunnel or running a TLS handshake between the relay node and the donor eNB. Third, a key K is generated in the donor eNB and sent inside an IPSec tunnel (or TLS tunnel) to the relay node or the key K is derived from the security association established for IPsec/TLS. The IPSec tunnel should preferably provide both integrity and confidentiality protection. Fourth, the key K is used to derive new versions of one or more of the encryption keys K_{UP-enc}, K_{RRC-enc}, and the integrity key K_{RRC-int}. To make it clear for both the donor eNB and the relay node when the key K shall start affecting the other keys, a signal could be sent from the donor eNB to the relay node (or from the relay node to the donor eNB) indicating when the change to the new keys shall be made. In some embodiments, the donor eNB can include an information element in an RRC reconfiguration message or an RRC security mode command, but it is possible that other messages are used or even that new message types are created to carry this information.

One approach to securing relay nodes uses IPsec (or TLS) to protect the User-UE control plane between the relay node and donor eNB and AS-level security mechanism to protect the user plane. With respect to protecting the User-UE control plane, an IPsec (or TLS) tunnel (in the approach where the key K is derived from the security association established via IPsec or TLS) is only used to provide integrity protection of the User-UE control plane between the relay node and the donor eNB. Providing confidentiality protection is optional; for confidentiality protection the system relies on the AS confidentiality protection of the user plane. However, if the secret key K discussed above is to be transmitted within the tunnel, then confidentiality protection is also needed. There are several ways to solve this problem. One approach is to first establish an IPsec or TLS tunnel with both integrity and confidentiality protection. Once the secret key K (or other confidential data) has been exchanged, then a new tunnel with only integrity protection could be established. Another approach is to always have both integrity and confidentiality protection for the tunnel. The keys used for AS protection are bound to the security association (keys) that are set-up and its associated authentication of the relay node as a genuine relay node (e.g. using certificates stored in the relay node's secure environment.

New security procedures are needed to protect user plane data using the techniques described above. Generally, the initial step is to authenticate the relay node as a UE using the USIM and apply standard (LTE-Uu) security mechanisms on the Un interface. In principle, this step only provides connectivity between the relay node and the donor eNB. The next step is to establish a security association between the relay node and the donor eNB. For instance, an IPsec tunnel may be established using, IKEv2 for the security association establishment. Related key(s) used to bind the existing AS security context to the IPsec security association negotiation and the associated relay node device authentication may be derived from the security association or the credentials used to establish the IPsec tunnel, or from information sent inside the tunnel. In the latter case, the information sent inside the tunnel could be sent in an S1AP message, or using some other protocol, such as HTTP.

Other approaches to deriving the intermediate key K are possible. As discussed earlier, one approach is to establish an application-layer tunnel, such as a TLS connection. Standardized key extraction methods (e.g., RFC 5705) can be used to establish one or more related keys. Still another method would be to use the device certificates to encrypt the key information to be transferred between the relay node and the donor eNB used to derive the related keys.

A common security association can be used to generate keys for both the IPsec (or TLS) tunnel and the related keys for binding of the AS security context, or different security associations could be generated for this purpose. A special case of the first alternative is that the common security association is used directly for IPsec, and then modified to be used for the AS security.

The related keys are used to modify the AS security context derived from the EPS AKA performed earlier. In some embodiments, the modified AS security context is taken into use before any User-UE control plane or user plane traffic is forwarded over the access stratum. Note that when the AS security context is modified, the keys for the RRC protection can also be modified. To initiate and synchronize the use of the modified AS security context, the system could use an intra-cell handover procedure, for example.

If the K_{eNB} is modified, special handling needs to be defined for what happens when the K_{eNB} is updated, e.g., at CONNECTED-IDLE-CONNECTED cycles, or (intra-cell) handovers. In many embodiments it may be simpler to derive the encryption and integrity keys directly and let the K_{eNB} be handled as already defined for LTE.

If the donor eNB fails to establish a security association with the relay node (e.g., an IPsec tunnel, if an IPsec tunnel is used to provide integrity protection for the User-UE control plane signaling), the donor eNB can restrict the access given to the relay node, e.g., to limit IP connectivity to only the enrollment server. Other possibilities for determining that access should be restricted may exist. As noted above, the MME does not have access to any information regarding whether the relay node has enrolled an operator certificate or not, and hence cannot provide this information to the donor eNB in the User-UE control plane setup for the relay node.

In some embodiments of the invention, IPsec is used to protect the User-UE control plane between the relay node and donor eNB, following the procedures for eNBs as described in clause 11 of TS 33.401. Note that only integrity protection may be provided for the purposes of protecting the control plane data (although confidentiality protection may be required for the exchange of related keys or data used to generate the related keys, as discussed above). In principle, encryption could also be applied, but is generally unnecessary, since encryption can also be applied by the radio protocols. Integrity protection prevents several different types of attacks—when combined with AS-level confidentiality protection, several other known attacks will be completely countered for signaling traffic. Of course, user plane traffic in this case is only confidentiality-protected. However, this is consistent with accepted principles for user plane traffic protection over the LTE-Uu air interface. The overhead caused by the IPsec or TLS tunnels would be negligible, as there is little signaling compared to user plane traffic. The AS-level security efficiency is the same as for LTE-Uu protection mechanisms.

With the solutions described herein, since the AS-level security is directly or indirectly bound to credentials securely stored on the relay node, the relay node is device-authenticated at the network access layer, thus preventing a number of other known threats. Further, it should be noted that non-access stratum (NAS) signaling from the relay node to the Relay-UE's MME will use keys derived from the K_{ASME} obtained by the LTE authentication procedure (called EPS AKA) performed using the USIM. These keys may be exposed if the interface between the UICC and the relay node is unprotected. However, since NAS messages are tunneled in the access stratum, they will be protected by the modified AS security context as soon as it has been established. Thus there is no possibility for an attack on the interface between the relay node and the donor eNB (Un) to succeed in modifying the NAS signaling from the relay node to the Relay-UE's MME. As described above, the AS signaling is also protected.

With respect to physical threats, it can be noted that if an attacker removes the USIM, the relay node lacking its USIM cannot be authenticated by the network. This means that a legitimate relay node cannot connect to the network and provide services, corresponding to any other denial of service attack like disturbing or eliminating the radio connectivity. An attacker could also insert the USIM into another relay node, but if the identities of the relay nodes are matched against a certain location, e.g., a tracking area, then a USIM used in an incorrect relay node would be detected.

Analysis of the solutions described above in view of the threat models developed in 3GPP shows that it is not necessary to have a protected interface between the UICC and the secure environment in the relay node. Furthermore, using relay node identities for tracking the topology of the access network eliminates the need to verify relay node UICC pairings. The final conclusion then is that removable UICCs can be used in relay nodes, simplifying the installation and maintenance of these nodes. Of course, the solutions described above generally assume that the relay node has a credential which can be used to establish the IPsec tunnel with the donor eNB. An example of such a credential is a device certificate, which could be enrolled in the same way that macro eNBs are enrolled.

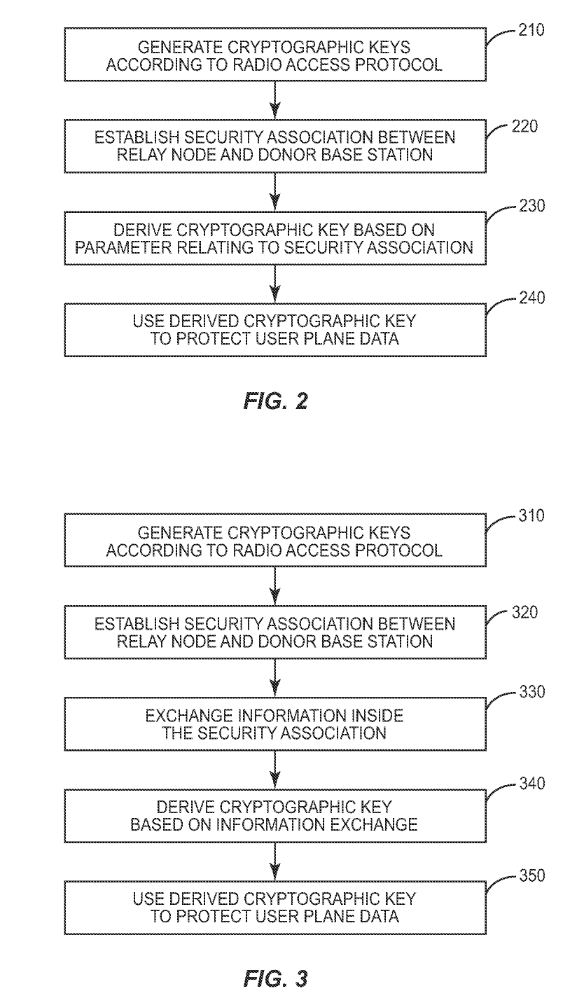

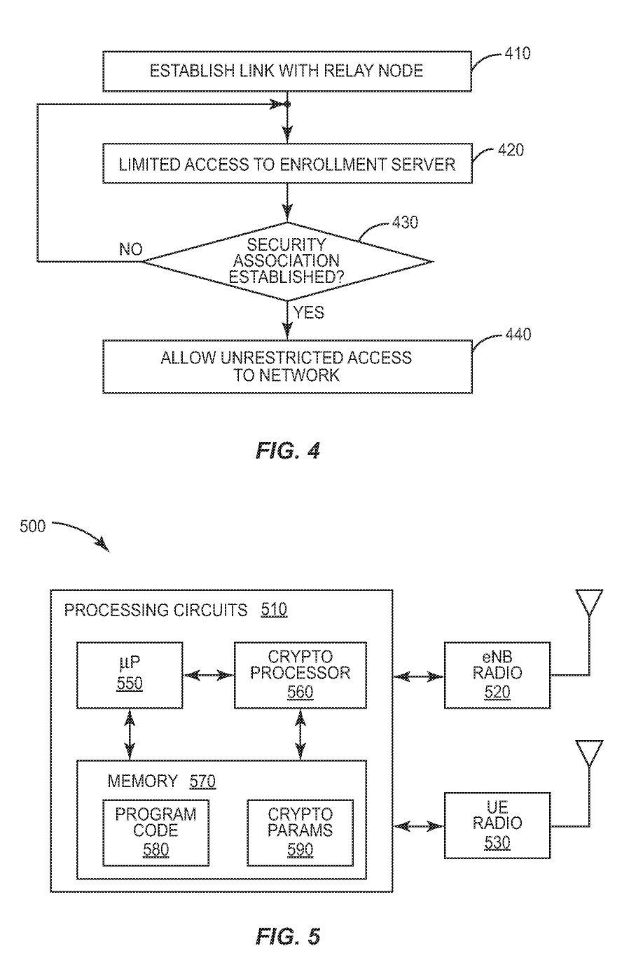

FIGS. 2, 3, and 4 illustrate process flows for carrying out several of the techniques described in detail above. FIGS. 2 and 3 illustrate closely related methods for securing relay node traffic such as might be performed at a relay node or a donor base station, or both. FIG. 4 illustrates another related method for providing only restricted network access to a relay node until it is determined that a security association has been established between the relay node and the donor base station.

Referring first to FIG. 2, the illustrated method for securely providing relay node services begins, as shown at block 210, with the generation of cryptographic keys according to a radio access protocol. This step refers to the conventional generation of keys according to LTE (or other) radio access protocol standards, such as the cryptographic keys used by the Packet Data Convergence Protocol (PDCP). As shown at block 220, a security association is then established between a relay node and a donor base station, using a credential stored at the relay node (e.g., an operator certificate)—in some embodiments this includes the establishment of an IPsec tunnel, while in others a TLS tunnel is formed.

As shown at block 230, at least one of the radio access protocol cryptographic keys generated earlier is used to derive a second cryptographic key, using a parameter related to the security association. In some embodiments, the second cryptographic key (an encryption key, for example) is derived using the stored credential, or one or more security association parameters relating to an established IPsec or TLS tunnel, or both. In any of these or in other embodiments, an intermediate key may be formed, using the stored credential, one or more parameters relating to the security association, or both, and the intermediate key then used to derive the second cryptographic key.

Deriving the second cryptographic key may be done in any of several ways. For instance, the second cryptographic key can be obtained by XORing the intermediate key and the first cryptographic key, in some embodiments. In other embodiments, the intermediate key, or a product of the intermediate key, or both, are used as an input to a pre-determined key generation function to produce the second cryptographic key. In still other embodiments, the intermediate key or a product of the intermediate key, or both, are placed in an initialization vector of a security algorithm to generate the second cryptographic key.

Finally, as shown at block 240, the second cryptographic key is used to protect user plane data. The second cryptographic key is used with conventional security algorithms to provide user control plane or user data plane traffic with integrity protection, confidentiality protection, or some combination of these.

A related method for implementation at a relay node and/or a donor base station, generally corresponding to the method of FIG. 2, is illustrated in FIG. 3. As shown at block 310, the method begins, as does the method of FIG. 2, with the generation of cryptographic keys according to a radio access protocol. Then, as shown at block 320, a security association is established between a relay node and a donor base station, using a credential stored at the relay node (e.g., an operator certificate). As with the method of FIG. 2, in some embodiments this includes the establishment of an IPsec tunnel, while in others a TLS tunnel is formed.

As shown at block 330, information is exchanged within the security association. This information is then used to derive a second cryptographic key from one of the earlier generated cryptographic keys, as shown at block 340. Thus, for example, the second cryptographic key is derived using information exchanged within an IPsec or TLS tunnel. The information exchanged within the security association may be encrypted, using public key encryption. The derivation of the second cryptographic key may involve any of the techniques discussed above. For instance, an intermediate key may be formed from information exchanged within the security association, and the intermediate key used to derive the second cryptographic key.

Finally, as shown at block 340, the second cryptographic key is used to protect user plane data. Once again, the second cryptographic key is used with conventional security algorithms to provide user control plane or user data plane traffic with integrity protection, confidentiality protection, or some combination of these.

FIG. 4 illustrates another method for securing relay services, such as might be implemented at a donor base station. The techniques illustrated in FIG. 4 may be combined with the techniques of FIG. 2 or 3, in various embodiments. As shown at block 410, the process begins with the establishment of a link between the donor base station and the relay node—this link may be established using normal attachment procedures. However, until it is determined that the relay node has the proper operator security credentials, the network access provided by the donor base station to the relay node is restricted. In particular, as shown at block 420, the relay node is only allowed access to an enrollment server and/or Operation and Maintenance (OAM) servers, so that it may carry out procedures for obtaining appropriate security credentials from the network operator, e.g., by enrolling a device certificate. Of course, various degrees of restricted access are possible; the point is that the donor base station (or other network node) is able to determine when to loosen these restrictions by evaluating whether the relay node has obtained the proper credentials.

The donor base station can tell that certificate enrollment procedures (or other enrollment procedures) are complete by evaluating whether a security association has been established between the donor base station and the relay node, because this establishment requires the relay node to have the proper stored credentials. This is shown at block 430. Once it is determined that a security association is established, unrestricted access to the network is allowed, as shown at block 440. (Of course, access to the network at this point might still involve some normal restrictions. However, the limitations of access to only those resources necessary for the enrollment, and possibly to specific Operation And Maintenance (OAM) are relaxed.)

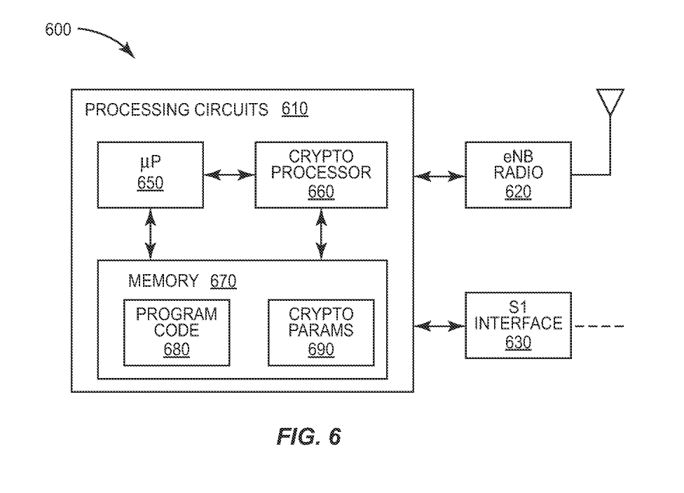

The solutions described above have been detailed in connection with relay nodes and donor base stations for use in LTE networks. Example configurations for an LTE relay node and LTE donor base station are illustrated in FIGS. 5 and 6, respectively. However, those skilled in the art will appreciate that the techniques and concepts described herein are more generally applicable to addressing security issues for relay nodes in general, and are thus not strictly limited to LTE implementations.

An example configuration for the relay node is pictured in FIG. 5, which illustrates a relay node 500 including an eNB radio section 520 for communication with one or more UEs, a UE radio 530 for communication with a host eNB, and a processor circuit 510. The processor circuit 510 includes one or more microprocessors 550, a cryptographic processing engine 560, and memory 570. The memory 570 includes program code 580, for use by the microprocessor 550 in carrying out one or more of the techniques described herein, and may also include secure storage 590 for storing cryptographic parameters, identifiers, certificates, and the like.

An example configuration for a donor base station is illustrated in FIG. 6. Donor base station 600 includes an eNB radio 620 for communicating with one or more UEs and/or one or more relay nodes, and an S1 interface circuit 630 for communicating with other nodes in the fixed network. Donor base station 600 also includes processing circuits 610, which are configured to carry out security-related processes complementary to those performed by the relay nodes, plus, in some cases, additional processes. The processing circuit 610 includes one or more microprocessors 650, a cryptographic processing engine 660, and memory 670. The memory 670 includes program code 680, for use by the microprocessor 650 in carrying out one or more of the techniques described herein, and may also include secure storage 690 for storing cryptographic parameters, identifiers, etc.

Those skilled in the art will appreciate that the various methods and processes described herein may be implemented using various hardware configurations that generally, but not necessarily, include the use of one or more microprocessors, microcontrollers, digital signal processors, or the like, coupled to memory storing software instructions for carrying out the techniques described herein. In particular, those skilled in the art will appreciate that the circuits of various embodiments of relay node 500 and donor base station 600 may be configured in ways that vary in certain details from the broad descriptions given above. For instance, one or more of the processing functionalities discussed above may be implemented using dedicated hardware, rather than a microprocessor configured with program instructions. Such variations, and the engineering tradeoffs associated with each, will be readily appreciated by the skilled practitioner. Since the design and cost tradeoffs for the various hardware approaches, which may depend on system-level requirements that are outside the scope of the present disclosure, are well known to those of ordinary skill in the art, further details of specific hardware implementations are not provided herein.

Indeed, all of the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method in a relay node for securely providing relay node services in a wireless communication system, the method comprising:
generating a first cryptographic key according to a radio access protocol;
establishing a security association between the relay node and the donor base station, using a credential stored at the relay node;
deriving a second cryptographic key from the first cryptographic key, using the stored credential or one or more parameters relating to the security association or information exchanged within the security association; and
using the second cryptographic key to protect user plane data relayed from one or more mobile terminals to the donor base station.

2. The method of claim 1, wherein generating the second cryptographic key comprises deriving the second cryptographic key using the stored credential, or one or more security association parameters relating to the security association, or both.

3. The method of claim 1, wherein generating the second cryptographic key comprises deriving the second cryptographic key based on information exchanged between the relay node and the donor base station within the security association.

4. The method of claim 1, wherein establishing a security association between the relay node and the donor base station comprises establishing an IPsec tunnel.

5. The method of claim 1, wherein establishing a security association between the relay node and the donor base station comprises establishing a Transport Layer Security (TLS) tunnel.

6. The method of claim 1, wherein the wireless communication system is an LTE system and the radio access protocol is the Packet Data Convergence Protocol (PDCP).

7. The method of claim 1, wherein deriving the second cryptographic key comprises deriving the second cryptographic key from a radio access protocol protection key.

8. The method of claim 1, further comprising generating an intermediate key based on the stored credential, or one or more parameters relating to the security association, or information exchanged within the security association; wherein deriving the second cryptographic key is based on the intermediate key.

9. The method of claim 8, wherein deriving the second cryptographic key comprises at least one of:
XORing the intermediate key and the first cryptographic key, to obtain the second cryptographic key;
using the intermediate key, or a product of the intermediate key, or both, as an input to a pre-determined key generation function, to produce the second cryptographic key; and
including the intermediate key or a product of the intermediate key, or both, in an initialization vector of a security algorithm.

10. The method of claim 1, further comprising encrypting the information exchanged within the security association using public key encryption and generating an intermediate key based on the exchanged information; wherein deriving the second cryptographic key is based on the intermediate key.

11. A relay node configured to provide relay services to mobile stations in a wireless communication system, the relay node comprising processing circuitry configured to:
generate a first cryptographic key according to a radio access protocol;
establish a security association between the relay node and the donor base station, using a credential stored at the relay node;
derive at least a second cryptographic key from the first cryptographic key, using the stored credential or one or more parameters relating to the security association or information exchanged within the security association; and
use the second cryptographic key to protect user plane data relayed from one or more mobile terminals to the donor base station.

12. The relay node of claim 11, wherein the processing circuit is configured to establish the security association between the relay node and the donor base station by establishing an IPsec tunnel.

13. The relay node of claim 12, wherein the processing circuitry is configured to derive the second cryptographic key using the stored credential, or one or more security association parameters relating to the IPsec tunnel, or both.

14. The relay node of claim 12, wherein the processing circuitry is configured to derive the second cryptographic key based on information exchanged inside the IPSec tunnel between the relay node and the donor base station.

15. The relay node of claim 11, wherein the processing circuit is configured to establish the security association between the relay node and the donor base station by establishing a Transport Layer Security (TLS) tunnel.

16. The relay node of claim 11, wherein the processing circuitry is further configured to generate an intermediate key based on the stored credential, or one or more parameters relating to the security association, or information exchanged within the security association, and to derive the second cryptographic key based on the intermediate key.

17. A method in a donor base station for supporting secure relay node services in a wireless communication system, the method comprising:
determining a first cryptographic key according to a radio access protocol, upon attachment by a relay node;
establishing a security association between the relay node and the donor base station, based on a credential stored at the relay node;
deriving at least a second cryptographic key from the first cryptographic key, using the stored credential or one or more parameters relating to the security association or information exchanged within the security association; and
using the second cryptographic key to protect user plane data sent to the relay node for transfer to one or more mobile terminals.

18. The method of claim 17, wherein establishing a security association between the relay node and the donor base station comprises establishing an IPSec tunnel.

19. The method of claim 17, wherein establishing a security association between the relay node and the donor base station comprises establishing a Transport Layer Security (TLS) tunnel.

20. The method of claim 17, wherein deriving the second cryptographic key comprises deriving the second cryptographic key from a radio access protocol protection key.

21. The method of claim 17, further comprising generating an intermediate key, based on the stored credential, or one or more parameters relating to the security association, or information exchanged within the security association; wherein deriving the second cryptographic key is based on the intermediate key.

22. The method of claim 17, further comprising restricting network access provided to the relay node until the security association is established.

23. The method of claim 22, wherein restricting network access comprises allowing the relay node to access an enrollment server, for retrieval of operator security credentials, prior to establishment of the security association.

24. A method in a donor base station for supporting secure relay node services in a wireless communication system, the method comprising:
establishing a security association between a relay node and the donor base station, based on a credential stored at the relay node; and
restricting network access provided to the relay node until the security association is established.

25. The method of claim 24, wherein establishing a security association between the relay node and the donor base station comprises establishing an IPsec tunnel or establishing a Transport Layer Security (TLS) tunnel.

26. The method of claim 24, wherein restricting network access comprises allowing the relay node to access an enrollment server for retrieval of operator security credentials, prior to establishment of the security association.

27. A donor base station configured to provide relay services to one or more mobile stations in a wireless communication system, via a relay node, the donor base station comprising processing circuitry configured to:
determine a first cryptographic key according to a radio access protocol, upon attachment by a relay node;
establish a security association between the relay node and the donor base station, based on a credential stored at the relay node;
derive a second cryptographic key from the first cryptographic key, using the stored credential or one or more parameters relating to the security association or information exchanged within the security association; and
use the second cryptographic key to protect user plane data sent to the relay node for transfer to one or more mobile terminals.

28. The donor base station of claim 27, wherein the processing circuitry is further configured to generate an intermediate key, based on the stored credential, or one or more parameters relating to the security association, or information exchanged within the security association, and to derive the second cryptographic key using the intermediate key.

29. The donor base station of claim 27, wherein the processing circuitry is further configured to restrict network access provided to the relay node until the security association is established.

30. The donor base station of claim 29, wherein the processing circuitry is configured to restrict network access by allowing the relay node to access an enrollment server, for retrieval of operator security credentials, prior to the establishment of the security association.

31. A donor base station configured to provide relay services to one or more mobile stations in a wireless communication system, via a relay node, the donor base station comprising processing circuitry configured to:
establish a security association between the relay node and a donor base station, based on a credential stored at the relay node; and
restrict network access provided to the relay node until the security association is established.

32. The donor base station of claim 31, wherein restricting network access comprises allowing the relay node to access an enrollment server, for retrieval of operator security credentials, prior to the establishment of the security association.
